(19) United States
(12) Patent Application Publication
(10) Pub. No.: US 2013/0134870 A1
(43) Pub. Date: May 30, 2013

(54) High-Pressure Discharge Lamp

(71) Applicants: Michael Boenigk, Berlin (DE); Marc Czichy, Berlin (DE)

(72) Inventors: Michael Boenigk, Berlin (DE); Marc Czichy, Berlin (DE)

(73) Assignee: OSRAM AG, Muenchen (DE)

(21) Appl. No.: 13/643,035

(22) PCT Filed: Apr. 14, 2011
(86) PCT No.: PCT/EP2011/055918

§ 371 Date: Feb. 15, 2013

(30) Foreign Application Priority Data
Apr. 23, 2010 (DE) 10 2010 028 156.5

(51) Int. Cl. H01J 61/54

(52) U.S. Cl. CPC H01J 61/54
USPC 313/623

(57) ABSTRACT

A high-pressure discharge lamp comprising a translucent discharge vessel which encloses a discharge space and has two sealed ends. Two electrodes extend from the sealed ends into the discharge space, and a fill is arranged in the discharge space for generating a gas discharge. Electrical feeds lead out of the sealed ends for supplying energy to the electrodes, with an electrically conductive layer acting as an ignition aid being arranged on the surface of the discharge vessel. The electrically conductive layer comprises at least a first layer section and a second layer section, the first layer section being arranged on a first sealed end of the discharge vessel and extends onto the surface of that region of the discharge vessel which encloses the discharge space. The second layer section is arranged on the second sealed end of the discharge vessel and extends onto the surface of that region of the discharge vessel which encloses the discharge space. The parts of the first and second layer sections which are arranged on the surface of that region of the discharge vessel which encloses the discharge space are arranged at a distance from one another, and the layer sections are DC-isolated.

The invention relates to a high-pressure discharge lamp according to the precharacterizing clause of patent claim 1.

### PRIOR ART

Such a high-pressure discharge lamp is disclosed, for example, in EP 1 632 985 A1. Said document describes a high-pressure discharge lamp for motor-vehicle headlamps, comprising a translucent discharge vessel which encloses a discharge space and has two sealed ends, and comprising two electrodes extending from the sealed ends into the discharge space and a fill arranged in the discharge space for generating a gas discharge, also comprising electrical feeds led out of the sealed ends for supplying energy to the electrodes. An electrically conductive layer acting as an ignition aid is arranged on the surface of the discharge vessel. This ignition aid layer is formed in one piece. It extends over the entire lengthwise extent of the discharge space: according to a symmetrical embodiment over both sealed ends of the discharge vessel and according to an asymmetrical embodiment only over one of the two sealed ends of the discharge vessel.

This one-piece ignition aid layer has the disadvantage that it does not allow combination with an auxiliary discharge used as an additional ignition aid in an outer bulb of the high-pressure discharge lamp, because it constitutes an electrical short circuit along the discharge vessel for such an auxiliary discharge.

The symmetrical embodiment of this one-piece ignition aid layer has the further disadvantage that, owing to its capacitive coupling with the two electrodes, the electric field is distributed symmetrically between the ignition aid layer and the two electrodes and only half the field strength is therefore available over each electrode. The asymmetrical embodiment of the one-piece ignition aid layer according to the prior art, on the other hand, has the further disadvantage that the degree of its effectiveness is dependent on the polarity of the half-waves of the ignition voltage pulses and on which of the two electrodes receives the “hot” potential of the ignition voltage pulses, that is to say the electrical potential which is high in relation to the ground potential.

### SUMMARY OF THE INVENTION

It is an object of the invention to provide a high-pressure discharge lamp of the species, which has improved ignition properties and does not present the disadvantages mentioned above.

This object is achieved according to the invention by a high-pressure discharge lamp having the features of patent claim 1. Particularly advantageous embodiments of the invention are described in the dependent patent claims.

The high-pressure discharge lamp according to the invention comprises a translucent discharge vessel which encloses a discharge space and has two sealed ends, and comprising two electrodes extending from the sealed ends into the discharge space and a fill arranged in the discharge space for generating a gas discharge, as well as electrical feeds led out of the sealed ends for supplying energy to the electrodes. An electrically conductive layer acting as an ignition aid is arranged on the surface of its discharge vessel. According to the invention, this electrically conductive layer consists of at least a first layer section and a second layer section, the first layer section being arranged on a first sealed end of the discharge vessel and extending onto the surface of that region of the discharge vessel which encloses the discharge space, and the second layer section being arranged on the second sealed end of the discharge vessel and extending onto the surface of that region of the discharge vessel which encloses the discharge space, such that the parts of the first and second layer sections which are arranged on the surface of that region of the discharge vessel which encloses the discharge space are arranged at a distance from one another and the layer sections are DC-isolated.

The two layer sections of the electrically conductive layer, which are arranged DC-isolated from one another, each have good capacitive coupling with the electrical feed which protrudes from the respective sealed end of the discharge vessel on which the layer section is arranged. This means that the first layer section has good capacitive coupling with the electrical feed which protrudes from the first sealed end of the discharge vessel, and the second layer section has good capacitive coupling with the electrical feed which protrudes from the second sealed end of the discharge vessel. In this way, for the effectiveness of the ignition aid layer according to the invention it is unimportant which of the two electrodes receives the ignition voltage pulses and which polarity the ignition voltage half-waves have. Owing to the DC-isolated arrangement of its two layer sections, the electrically conductive layer acting as an ignition aid is also suitable for generating an auxiliary discharge in the intermediate space between the discharge vessel and an outer bulb, directly over the discharge vessel, which is formed between the two layer sections and reduces the ignition voltage necessary for igniting the gas discharge between the two electrodes.

Preferably, the two layer sections of the electrically conductive layer acting as an ignition aid are also arranged DC-isolated from the electrodes and the voltage supply of the high-pressure discharge lamp. In this way, additional electrical connections for the high-pressure discharge lamp are not required.

Preferably, the first layer section extends on the surface of that region of the discharge vessel which encloses the discharge space in the direction of the second sealed end at least as far as the height of the second electrode projecting from the second sealed end into the discharge space and, similarly, the second layer section extends on the surface of that region of the discharge vessel which encloses the discharge space in the direction of the first sealed end preferably at least as far as the height of the first electrode projecting from the first sealed end of the discharge vessel into the discharge space. This configuration of the two layer sections ensures that the capacitive coupling between the first layer section and the electrical feed projecting from the first sealed end of the discharge vessel is greater than the capacitive coupling between the first layer section and the second electrode projecting from the second sealed end of the discharge vessel and projecting into the discharge space. Similarly, the capacitive coupling between the second layer section and the electrical feed projecting from the first sealed end of the discharge vessel is greater than the capacitive coupling between the second layer section and the first electrode projecting from the first sealed end of the discharge vessel and projecting into the discharge space. Consequently, during the ignition phase of the high-pressure discharge lamp an electric field having a high field strength can be set up between the first layer section and the second electrode projecting from the second sealed end of the discharge vessel into the discharge space, or between the second layer section and the first electrode projecting from the first sealed end of the discharge vessel into the discharge space, which is sufficient—depending on the polarity of the ignition voltage pulses and depending on which of the two electrodes receives the ignition voltage pulses—in order to generate a dielectric barrier discharge between the first layer section and the second electrode or between the second layer section and the first electrode. As a result of this dielectric barrier discharge, the ignition voltage required for igniting the gas discharge between the two electrodes is reduced and therefore the ignitability of the high-pressure discharge lamp according to the invention is improved.

According to the preferred embodiments of the invention, the first and second layer sections respectively extend over the entire lengthwise extent of that region of the discharge vessel which encloses the discharge space. The term lengthwise extent refers here to the extent parallel to an imaginary line joining the discharge-side ends of the two electrodes. The first layer section is preferably not, however, extended as far as the second sealed end of the discharge vessel, in order to avoid a capacitive short circuit. For the same reason, the second layer section is also not extended as far as the first sealed end of the discharge vessel.

The high-pressure discharge lamp according to the invention preferably has an outer bulb, which encloses at least the region of the discharge vessel provided with the electrically conductive layer, in order to protect this layer from damage and in order to permit the formation of an auxiliary discharge between the first and second layer sections of the electrically conductive layer, in the intermediate space between the discharge vessel and the outer bulb, during the ignition phase of the high-pressure discharge lamp. To this end, additionally, the air pressure in the intermediate space may also be reduced in relation to normal pressure, or for example a gas fill containing nitrogen or noble gas with a cold fill pressure (that is to say the fill pressure measured at a temperature of 22° C.) in the range from 5 kPa to 15 kPa may be provided in the intermediate space.

Preferably, the electrically conductive layer of the high-pressure discharge lamp according to the invention is formed to be translucent, and particularly preferably transparent, in order to entail the least possible light absorption by this layer so that the high-pressure discharge lamp can be used as a light source in a motor vehicle headlamp.

According to an exemplary embodiment of the invention, the parts of the first and second layer sections which extend on that region of the discharge vessel which encloses the discharge space are respectively formed in the shape of strips. This can ensure that virtually no light is absorbed by the electrically conductive layer acting as an ignition aid. Furthermore, these layer sections formed in the shape of strips may be arranged on a surface region of the discharge vessel which lies opposite an electrical return feed led back to the lamp cap, and which has no function for the projection in the headlamp.

According to another exemplary embodiment of the invention, the first and second layer sections respectively cover a significant part of the surface of a half-shell of an ellipsoidal or spherical region, of the discharge vessel, which encloses the discharge space. In this case, the layer sections may be used for selective heating of the coated regions of the discharge vessel which surround the discharge space, since the layer sections reflect a part of the infrared radiation generated in the gas discharge back into the discharge space.

### DESCRIPTION OF THE PREFERRED EXEMPLARY EMBODIMENTS

The invention will be explained in more detail below with the aid of preferred exemplary embodiments.

FIG. 1 shows a side view of a high-pressure discharge lamp according to the first exemplary embodiment of the invention

FIG. 2 shows a side view of the discharge vessel of a high-pressure discharge lamp according to the second exemplary embodiment of the invention

FIG. 3 shows a plan view of the lower side of the discharge vessel of a high-pressure discharge lamp according to the third exemplary embodiment of the invention

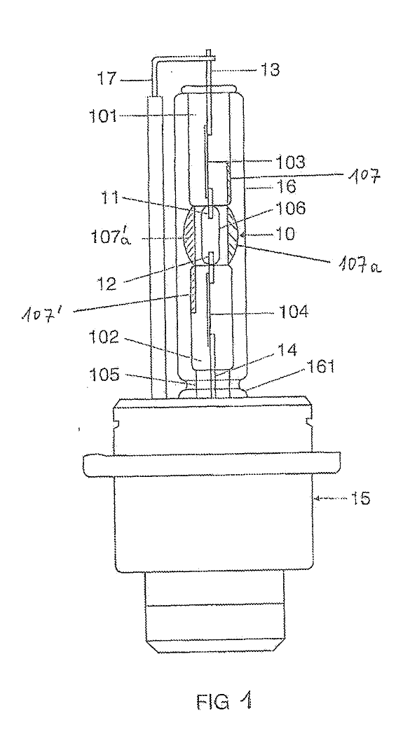

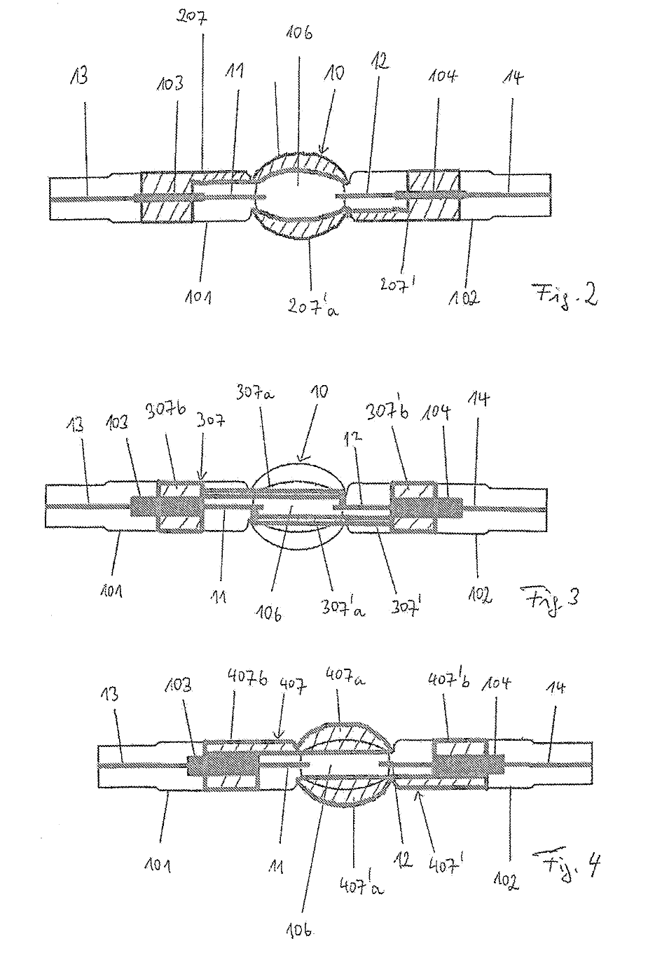

FIG. 4 shows a plan view of the lower side of the discharge vessel of a high-pressure discharge lamp according to the fourth exemplary embodiment of the invention

The first exemplary embodiment of the invention schematically represented in FIG. 1 is a mercury-free halogen metal vapor high-pressure discharge lamp having an electrical power consumption of approximately 35 watts. This lamp is intended for use in a motor vehicle headlamp. It has a discharge vessel 10 consisting of quartz glass, sealed on two sides and having a volume of 24 mm³, in which an ionizable fill consisting of xenon and halides of the metals sodium, scandium, zinc and indium is hermetically enclosed. In the region of the discharge space 106, the inner contour of the discharge vessel 10 is formed circular-cylindrically and its outer contour is formed ellipsoidally. The inner diameter of the discharge space 106 is 2.6 mm and its outer diameter is 6.3 mm. The two ends 101, 102 of the discharge vessel 10 are respectively sealed by means of a fused-in molybdenum foil 103, 104. Two electrodes 11, 12 protrude into the discharge space 106 of the discharge vessel 10, between which the arc discharges responsible for the light emission are formed during operation of the lamp. The electrodes 11, 12 consist of tungsten. Their thickness, or their diameter, is 0.30 mm. The optically effective distance between the electrodes 11, 12 is 4.2 mm. The electrodes 11, 12 are respectively connected electrically conductively via one of the fused-in molybdenum foils 103, 104 and via the electrical supply wire 13 on the other side from the cap and the electrical return feed 17, or via the electrical supply wire 14 on the cap side, to an electrical connection of the lamp cap 15 which essentially consists of plastic. The molybdenum foil 103 which is embedded in the first sealed end 101 of the discharge vessel 10, on the other side from the cap, the electrical supply wire 13 which protrudes from this first sealed end 101, and the electrical return feed 17 led back to the lamp cap 15, form the electrical feed for the first electrode 11 projecting from the first sealed end 101 into the discharge space 106. Similarly, the molybdenum foil 104 embedded in the second sealed end 102 of the discharge vessel 10, next to the cap, and the electrical supply wire 14 protruding from this second sealed end 102, form the electrical feed for the second electrode 12. The discharge vessel 10 is encapsulated by a vitreous outer bulb 16.

The discharge vessel 10 is provided on its outer surface with a two-part electrically conductive layer 107, 107′, which is used as an ignition aid and is formed to be translucent or transparent. This layer 107, 107′ consists of a first layer section 107 which is arranged on the first sealed end 101 of the discharge vessel 10, on the other side from the cap, and is extended onto the discharge vessel region which encloses the discharge space 106, and of a second layer section 107′ which is arranged on the second sealed end 102 of the discharge vessel 10, next to the cap, and is likewise extended onto the discharge vessel region which encloses the discharge space 106. However, the two layer sections 107, 107′ are arranged at a distance from one another and are DC-isolated from one another. The first layer section 107 is arranged on a surface region of the discharge vessel 10 facing toward the electrical return feed 17, and the second layer section 107′ is arranged on a surface region of the discharge vessel 10 facing away from the electrical return feed 17. Since the high-pressure discharge lamp is conventionally used in a horizontal operating position, that is to say with horizontally extending electrodes 11, 12, such that the electrical return feed 17 extends below the electrodes 11, 12, the first layer section 107 is arranged on the upper side of the discharge vessel 10 and the second layer section 107′ is arranged on the lower side of the discharge vessel 10. The two layer sections 107, 107′ are arranged DC-isolated from the electrodes 11, 12. The first layer section 107 has good capacitive coupling with the molybdenum foil 103 embedded in the first sealed end 101, and the second layer section 107′ has good capacitive coupling with the molybdenum foil 104 embedded in the second sealed end 102. The sealed ends 101, 102 are formed as pinch seals and the molybdenum foils 103, 104 are embedded hermetically therein. The sealed ends 101, 102 are therefore flattened and consequently have a smaller thickness perpendicularly to the plane defined by the surfaces of the molybdenum foils then parallel to this plane. Those parts of the layer sections 107, 107′ which are arranged on the sealed ends 101, 102 extend essentially parallel to the molybdenum foils 103, 104. The part 107a of the first layer section 107, which is arranged on the upper side of that region of the discharge vessel 10 which encloses the discharge space 106, extends over the entire lengthwise extent of the discharge space 106. Correspondingly, the part 107′a of the second layer section 107′, which is arranged on the lower side of that region of the discharge vessel 10 which encloses the discharge space 106, likewise extends over the entire lengthwise extent of the discharge space 106. The parts 107a, 107′a of the two layer sections 107, 107′ are therefore arranged on different half-shells of that region of the discharge vessel 10 which encloses the discharge space.

The layer sections 107, 107′ are formed essentially in the shape of strips and follow the curvature of the surface of the discharge vessel 10. They 107, 107′ consist of doped tin oxide, for example of tin oxide doped with fluorine or with antimony or, for example, of tin oxide doped with boron and/or with lithium. The high-voltage pulses for igniting the gas discharge between the electrodes 11, 12 are, for safety reasons, conventionally supplied to the second electrode 12 via the electrical supply wire 14 next to the cap.

The intermediate space between the outer bulb 16 and the discharge vessel 10 is filled with an inert gas having a cold fill pressure in the range from 5 kPa to 15 kPa. The term cold fill pressure refers to the fill pressure which is measured at a temperature of 22° C. Small amounts of oxygen are mixed with the inert gas. The amount of oxygen is set so that, on the one hand, diffusion of oxygen out of the tin oxide layer 107 is prevented and, on the other hand, no oxidation of the dopants in the tin oxide coating 107, 107′ is induced. To this end, even an oxygen content of a few ppm is sufficient, for example an oxygen content of 100 ppm (proportion by weight) in the fill gas. The inert gas is preferably nitrogen, a noble gas, a noble gas mixture or a nitrogen/noble gas mixture. As an alternative to inert gas, however, the intermediate space between the discharge vessel 10 and the outer bulb may also be filled with air, for example with a cold fill pressure in the range from 5 kPa to 15 kPa.

FIGS. 2 to 4 schematically represent further exemplary embodiments of the invention for the configuration of the two-part electrically conductive layer acting as an ignition aid.

The high-pressure discharge lamps according to the further exemplary embodiments have the same design as the high-pressure discharge lamp explained in detail above according to the first exemplary embodiment of the invention, as depicted in FIG. 1. The high-pressure discharge lamps according to the further exemplary embodiments differ from the high-pressure discharge lamp according to the first exemplary embodiment of the invention only by the configuration of the ignition aid layer 107, 107′. In all other details, all the exemplary embodiments of the invention correspond to one another. For this reason, only the discharge vessel of the high-pressure discharge lamp, with the two-part ignition aid layer, is depicted in FIGS. 2 to 4, and the same references are used in FIGS. 1 to 4 for identical parts of the high-pressure discharge lamps.

FIG. 2 schematically represents the two-part ignition aid layer 207, 207′ according to the second exemplary embodiment of the invention. The layer sections 207, 207′ according to the second exemplary embodiment of the invention differ from the layer sections 107, 107′ according to the first exemplary embodiment only in that those parts of the layer sections 207, 207′ which are arranged on the sealed ends 101, 102 annularly enclose the sealed ends 101, 102 in the region of the molybdenum foils 103, 104. The part 207a of the first layer section 207 is arranged on the upper side of that region of the discharge vessel 10 which encloses the discharge space 106, and it extends over the entire lengthwise extent of the discharge space 106. However, the part 207a extends only over a part of the circumference of the upper half-shell of the ellipsoidally shaped region of the discharge vessel 10. The part 207′a of the second layer section 207′ is arranged on the lower side of that region of the discharge vessel 10 which encloses the discharge space 106, and it extends over the entire lengthwise extent of the discharge space 106. However, the part 207′a extends only over a part of the circumference of the lower half-shell of the ellipsoidally shaped region of the discharge vessel 10. The lower side, or lower half-shell, of the ellipsoidally shaped region of the discharge vessel 10 faces toward the electrical return feed 17 and the upper side, or upper half-shell, of the ellipsoidally shaped discharge vessel 10 faces away from the electrical return feed 17. This orientation applies for all the exemplary embodiments.

FIG. 3 schematically represents the two-part ignition aid layer 307, 307′ according to the third exemplary embodiment of the invention. The two layer sections 307, 307′ are arranged on the lower side of the discharge vessel 10. Those parts 307b, 307′b of the two layer sections 307, 307′ which are arranged on the sealed ends 101, 102 extend in the region of the molybdenum foils 103, 104 over the entire width of the sealed ends 101, 102 in order to permit good capacitive coupling. The parts 307a, 307′a of the two layer sections 307, 307′ extended onto the lower half-shell of that region of the ellipsoidally shaped discharge vessel 10 which encloses the discharge space 106 are formed as narrow strips, which extend parallel to one another on the lower half-shell and respectively extend over the entire lengthwise extent of the lower half-shell of the ellipsoidally shaped region of the discharge vessel 10. The strip-shaped part 307a extends onto the first sealed end 101 and is connected there to the other part 307b of the first layer section 307. Correspondingly, the strip-shaped part 307′a extends onto the second sealed end 102 and is connected there to the other part 307′b of the second layer section 307′.

FIG. 4 schematically represents the two-part ignition aid layer 407, 407′ according to the fourth exemplary embodiment of the invention. Both layer sections 407, 407′ are arranged on the lower side of the discharge vessel 10. Those parts 407b, 407′b of the two layer sections 407, 407′ which are arranged on the sealed ends 101, 102 extend in the region of the molybdenum foils 103, 104 over the entire width of the sealed ends 101, 102 and respectively induce good capacitive coupling with the corresponding molybdenum foil 103 or 104. The parts 407a, 407′a of the two layer sections 407, 407′ extended onto the lower half-shell of that region of the ellipsoidally shaped discharge vessel 10 which encloses the discharge space 106 are formed as wide strips, which extend parallel to one another on the lower half-shell and respectively extend over the entire lengthwise extent of the lower half-shell of the ellipsoidally shaped region of the discharge vessel 10. The strip-shaped part 407a extends onto the first sealed end 101 and is connected there to the other part 407b of the first layer section 407. Correspondingly, the strip-shaped part 407′a extends onto the second sealed end 102 and is connected there to the other part 407′b of the second layer section 407′. The strip-shaped parts 407a and 407′a extend perpendicularly to the lengthwise extent of the discharge space 106, respectively over about one third of the circumference of the lower half-shell of the ellipsoidally shaped region of the discharge vessel 10.

1. A high-pressure discharge lamp comprising a translucent discharge vessel which encloses a discharge space and has two sealed ends, and comprising two electrodes extending from the sealed ends into the discharge space and a fill arranged in the discharge space for generating a gas discharge, also comprising electrical feeds led out of the sealed ends for supplying energy to the electrodes, an electrically conductive layer acting as an ignition aid being arranged on the surface of the discharge vessel,
wherein the electrically conductive layer comprises at least a first layer section and a second layer section, the first layer section being arranged on a first sealed end of the discharge vessel and extending onto the surface of that region of the discharge vessel which encloses the discharge space, and the second layer section being arranged on the second sealed end of the discharge vessel and extending onto the surface of that region of the discharge vessel which encloses the discharge space,
such that the parts of the first and second layer sections which are arranged on the surface of that region of the discharge vessel which encloses the discharge space are arranged at a distance from one another and the layer sections are DC-isolated.

2. The high-pressure discharge lamp as claimed in claim 1, wherein the first layer section extends on the surface of that region of the discharge vessel which encloses the discharge space in the direction of the second sealed end at least as far as the height of the second electrode projecting from the second sealed end into the discharge space, and wherein the second layer section extends on the surface of that region of the discharge vessel which encloses the discharge space in the direction of the first sealed end at least as far as the height of the first electrode projecting from the first sealed end into the discharge space.

3. The high-pressure discharge lamp as claimed in claim 1, wherein the first and second layer sections respectively extend over the entire lengthwise extent of that region of the discharge vessel which encloses the discharge space.

4. The high-pressure discharge lamp as claimed in claim 1, wherein the parts of the first and second layer sections which extend on that region of the discharge vessel which encloses the discharge space are respectively formed in the shape of strips.

5. The high-pressure discharge lamp as claimed in claim 4, wherein the layer sections formed in the shape of strips are arranged on a surface region of the discharge vessel which lies opposite an electrical return feed extending outside the discharge vessel and led back to a lamp cap of the high-pressure discharge lamp.

6. The high-pressure discharge lamp as claimed in claim 1, wherein the electrically conductive layer is formed to be translucent.

7. The high-pressure discharge lamp as claimed in claim 1, wherein the high-pressure discharge lamp has an outer bulb which encloses at least the region of the discharge vessel provided with the electrically conductive layer.
